(19) United States
(12) Patent Application Publication
(10) Pub. No.: US 2025/0263552 A1
(43) Pub. Date: Aug. 21, 2025

(54) SYSTEMS AND METHODS FOR SEQUESTERING CARBON

(71) Applicant: Modern Hydrogen, Inc., Bothell, WA (US)

(72) Inventors: Alex Pearse, Bothell, WA (US); Emily Houston, Bothell, WA (US); Michael Baba, Bothell, WA (US); Hussain Bahia, Chicago, IL (US)

(21) Appl. No.: 19/055,034

(22) Filed: Feb. 17, 2025

Related U.S. Application Data
(60) Provisional application No. 63/554,851, filed on Feb. 16, 2024.

(51) Int. Cl. C08L 95/00; C09C 1/50

(52) U.S. Cl. CPC C08L 95/00; C09C 1/50; C08L 2555/34; C08L 2555/54

(57) ABSTRACT

Embodiments include a binder mixture, where the binder mixture includes a carbon coproduct from a pyrolysis reaction and a binding agent. Some embodiments include a method of producing a pavement mixture, including receiving a carbon coproduct from a pyrolysis reaction, receiving a binding agent, and blending together the carbon coproduct and the binding agent. Some embodiments include a method of producing a carbon coproduct, including receiving a hydrocarbon, tailoring a pyrolysis reactor to control a carbon coproduct, splitting the hydrocarbon within the pyrolysis reactor, and separating the hydrogen gas and the carbon coproduct, where the carbon coproduct is tailored for a binder mixture. Some embodiments include a system for producing pavement, including a pyrolysis reactor, resulting in a hydrogen gas product and a carbon coproduct, and a pavement system, where the pavement system forms a pavement mixture comprising the carbon coproduct.

### RELATED APPLICATIONS

This application claims the benefit of U.S. Provisional Patent Application No. 63/554,851, filed Feb. 16, 2024, the entire contents of which are incorporated herein by reference.

### FIELD

This disclosure generally relates to pyrolysis reactions and sequestering carbon. More particularly, the present disclosure relates to uses for carbon coproduct from such reactions.

### BACKGROUND

Natural gas, renewable natural gas, and/or other hydrocarbon fuels can be used to decarbonize several applications using a pyrolysis reactor capable of generating hydrogen with low carbon intensity while simultaneously producing a carbon co-product. The hydrogen can replace a portion (or all) of the natural gas, renewable natural gas, and/or other hydrocarbon fuels in the application. Purely by way of example, hydrogen gas can replace a portion (or all) of the natural gas consumed by a furnace to heat a residential space (e.g., a home, apartment, and/or the like) and/or a commercial building (e.g., a store, office building, and/or the like). The carbon co-product, meanwhile, can be collected to sequester the carbon, thereby reducing the emissions associated with the natural gas, renewable natural gas, or other hydrocarbon fuels in the various applications. However, it is difficult to find applications for the carbon coproduct. For example, it is difficult to achieve a match between the characteristics and volume of the solid carbon coproduct and a specific application for the carbon. As a result, while pyrolysis reactors provide a mechanism to separate carbon from hydrogen gas (e.g., to reduce carbon dioxide emissions associated with the hydrocarbons), fully sequestering the carbon from the reaction remains an issue.

Bitumen (also known as asphalt binder) is a constituent of petroleum that is the liquid binder that holds asphalt together. While bitumen provides a strong, water and oil-resistant adhesive for the components of asphalt (and related pavement products), bitumen is the most energy, emissions, and cost-intensive ingredient in pavement products. Accordingly, the asphalt industry aims to reduce the amount of bitumen it uses to save money and to lower the embodied carbon dioxide equivalent (CO₂ₑ) in asphalt materials. For example, recent efforts have explored using recycled plastics and rubber as aggregates to reduce the total amount of binder required. In some instances, it can be desired for the additives to also increase the performance of the asphalt through reinforcement, solid state lubrication during mixing, protection against oxidation, and various other effects. However, achieving this benefit typically requires flexibility in engineering the production process of the additive, and many additive streams are decoupled from the asphalt industry and as such must be used “as-is.” As a result, there have been issues with those recycled products damaging a performance of the resulting pavement, not actually reducing the amount of bitumen binder required to form a finished product, negatively impacting cost, and/or negatively affecting the environmental impact of the pavement products. For example, the additive materials can dramatically increase the viscosity of the bitumen, in turn undermining the processibility of the bitumen as a binder for the asphalt.

### SUMMARY

In general, this disclosure is directed to pyrolysis reactions and sequestering carbon and, more particularly, to uses for carbon coproduct from such reactions. In one example, the present disclosure includes a binder mixture, where the binder mixture comprises a carbon coproduct and a binding agent. The carbon coproduct is a coproduct from a pyrolysis reaction.

In another example, the present disclosure includes a method of producing a pavement mixture. The method can include receiving a carbon coproduct, where the carbon coproduct is a coproduct from a pyrolysis reaction. The method can also include receiving a binding agent. The method can also include blending together the carbon coproduct and the binding agent.

In another example, the present disclosure includes a method of producing a carbon coproduct. The method can include receiving a hydrocarbon. The method can also include tailoring a pyrolysis reactor to control a carbon coproduct. The method can also include splitting the hydrocarbon within the pyrolysis reactor such that at least a portion of the hydrocarbon converts into hydrogen gas and the controlled carbon coproduct. The method can also include methods of altering the carbon coproduct through altering the reaction kinetics, such as including catalytic materials or nonthermal sources of energy (for example, from microwave or nonthermal/“cold” plasma sources). The method can also include separating the hydrogen gas and the carbon coproduct, where the carbon coproduct is tailored for a binder mixture.

In another example, the present disclosure includes a system for producing pavement. The system can include a pyrolysis reactor, where the pyrolysis reactor heats hydrocarbon, resulting in a hydrogen gas product and a carbon coproduct. The system can also include a pavement system (also sometimes known as a “mix design”), where the pavement system forms a pavement mixture comprising the carbon coproduct.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic diagram of a pyrolysis reaction, according to an embodiment.

FIG. 2 is a schematic diagram of an example pavement mixture, according to an embodiment.

FIG. 3 is a schematic diagram of an example pavement mixture, according to an embodiment.

FIG. 4 is a flow diagram of an example method of producing a pavement mixture, according to an embodiment.

FIG. 5 is a flow diagram of an example method of producing a carbon coproduct, according to an embodiment.

FIG. 6 is a schematic diagram of an example system for producing pavement, according to an embodiment.

FIG. 7 is a schematic diagram of an example pyrolysis combined system, according to an embodiment.

FIG. 8 is a schematic diagram of an example asphalt combined system, according to an embodiment.

FIG. 9 is a schematic diagram of an example cement combined system, according to an embodiment.

FIG. 10 is a plot of positive effects of tuned pyrolysis carbon added to asphalt, according to an embodiment.

FIG. 11 is a graph showing mixture viscosity with the addition of the tuned pyrolysis carbon, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

In pyrolysis of hydrocarbons, the hydrocarbon primarily splits into hydrogen gas (H₂) and solid carbon (C) (referred to herein as carbon coproduct). Sometimes, other intermediate hydrocarbon products (in the class of polyaromatic hydrocarbons such as naphthalene, anthracene, phenanthrene, pyrene, chrysene, fluoranthene, and others) are also produced in smaller quantities. The pyrolysis of the hydrocarbons (e.g., natural gas, pure methane, and/or other suitable hydrocarbons) can produce significant amounts of solid carbon as a coproduct of the hydrogen gas. While the solid carbon can have desirable attributes and/or properties (referred to collectively as “characteristics”), it is difficult to achieve a match between the characteristics and volume of the solid carbon coproduct and a specific application for the carbon. As a result, while pyrolysis reactors provide a mechanism to separate carbon from hydrogen gas (e.g., to reduce carbon dioxide emissions associated with the hydrocarbons), fully sequestering the carbon from the reaction remains an issue.

Examples of suitable pyrolysis reactors are illustrated in the commonly assigned U.S. Pat. No. 11,897,768, U.S. Non-Provisional patent application Ser. No. 17/832,516, U.S. Non-Provisional patent application Ser. No. 17/503,187, U.S. Non-Provisional patent application Ser. No. 17/710,810, U.S. Provisional Patent Application No. 63/592,904, and U.S. Provisional Patent Application No. 63/592,906, the entireties of each of which are incorporated herein by reference. In such pyrolysis reactors, the associated carbon intensity of produced solid carbon can be lower than 1, 2, or 3 kilograms of carbon dioxide equivalent per kilogram of solid carbon produced (kg CO₂ₑ/kg). The associated carbon intensity of produced solid carbon from these pyrolysis reactors, depending on the process condition and method of allocation, can be as low as 2 kg CO₂ₑ/kg, 1 kg CO₂ₑ/kg, 0 kg CO₂ₑ/kg, or even below 0 kg CO₂ₑ/kg. when the input feedstock to the pyrolysis reactor is comprised partly or entirely of renewable natural gas, biomethane, and/or a similar low- CO₂ₑ input. In some such embodiments and depending on the allocation scheme, the carbon intensity can be as low as −10 kg CO₂ₑ/kg.

Systems and methods for sequestering carbon-containing materials generated by the pyrolysis of hydrocarbon fuels are disclosed herein while reducing the carbon intensity of carbon-containing products (e.g., asphalt and other pavement products). For example, the systems and methods disclosed herein can use and/or modify a pyrolysis system to generate hydrogen gas and a carbon coproduct (e.g., solid carbon combined with various byproducts from the pyrolysis reaction). The systems and methods disclosed herein then use the carbon coproduct to displace an incumbent material of a finished carbon-containing product. Because the carbon coproduct results from a carbon-sequestering pyrolysis process, the carbon coproduct can have a relatively low CO₂ₑ compared to the displaced incumbent materials. As a result, the finished carbon-containing product can have a lower overall CO₂ₑ compared to traditional forms of the carbon-containing product.

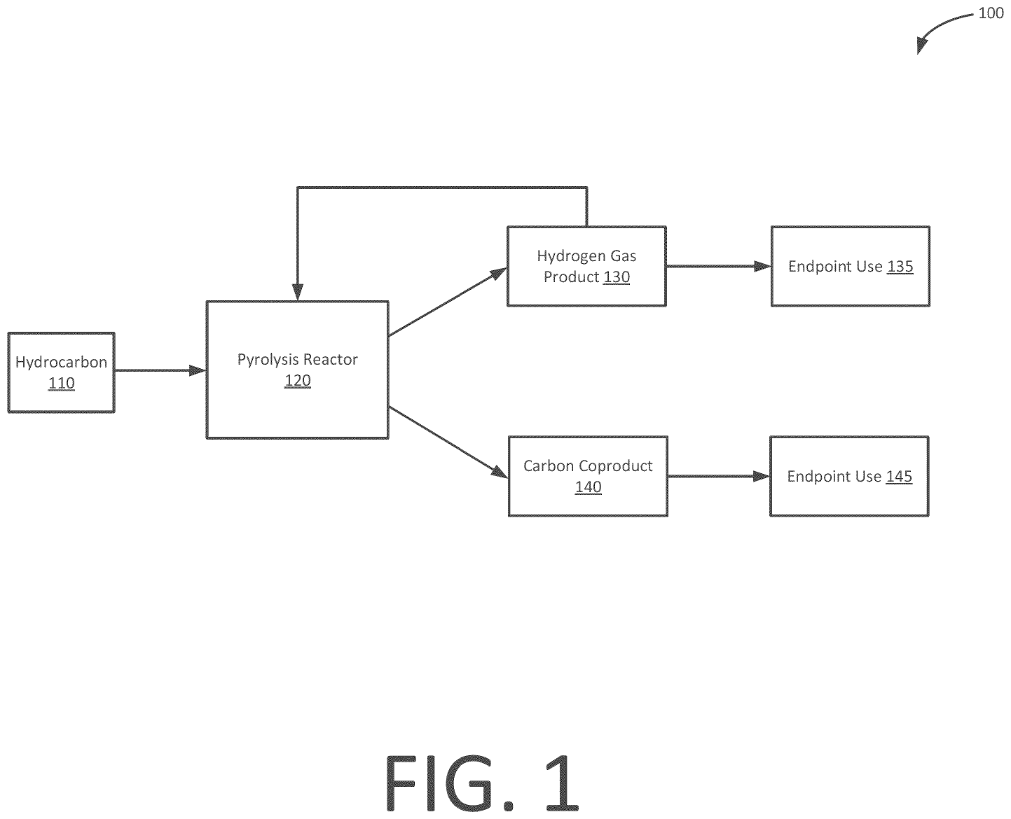

FIG. 1 illustrates an example pyrolysis reaction 100, according to an embodiment. As discussed herein, a pyrolysis reaction 100 can input hydrocarbon(s) 110 into a pyrolysis reactor 120. The pyrolysis reactor 120 can split the hydrocarbon(s) (for example, by chemical degradation). In some embodiments, this includes heating the hydrocarbon(s) 110 to a high temperature (referred to herein as a reaction temperature). The hydrocarbon(s) 110 convert into hydrogen gas and solid carbon (for example, by heating the hydrocarbon(s) above their decomposition temperature, which can break chemical bonds in its molecules). Therefore, the pyrolysis reactor 120 can output hydrogen gas product 130 and carbon coproduct 140. In some embodiments, as depicted in FIG. 1, at least a portion of the hydrogen gas product 130 can go to an endpoint use 135. An endpoint use, as discussed herein, is simply an application/use for the endpoints (in this instance, hydrogen gas and carbon coproduct) of the pyrolysis reaction. In some instances, an endpoint use 135 of the hydrogen gas product 130 can be replacing a portion (or all) of the natural gas, renewable natural gas, and/or other hydrocarbon fuels in various applications with hydrogen gas product 130. In some embodiments, all of the hydrogen gas product 130 can go to one or more endpoint uses 135. In some embodiments, as depicted in FIG. 1, at least a portion of the hydrogen gas product 130 can be recycled and used to help power the pyrolysis reactor 120.

In some embodiments, the carbon coproduct 140 can go to an endpoint use 145. As discussed herein, it can be difficult to find uses/applications for the carbon coproduct 140 due to its characteristics and volume. However, the carbon coproduct 140 can have desirable attributes and/or properties (referred to collectively as “characteristics”) that would be helpful in various endpoint uses 145. An example endpoint use 145 of carbon coproduct 140 is in pavement (for example, as part of a pavement binder). Using the carbon coproduct 140 in an endpoint use 145 (such as in pavement) can help fully sequester the carbon from the reaction (i.e., as the carbon coproduct 140 can be sequestered in the endpoint use 145).

As an example endpoint use 145 in pavement, the carbon coproduct 140 can replace a portion of the binding agent (for example, bitumen) in asphalt to create a modified binder. In some embodiments, the modified binder has a negligible effect on various performance metrics of the asphalt (or other pavement products) while reducing the cost of manufacturing the asphalt and/or reducing emissions from the manufacturing process. In some embodiments, the modified binder improves various performance metrics of the asphalt (or other pavement products). In other embodiments, the carbon coproduct can displace other portions of the asphalt mixture, including mineral filler, other fines, or specialty additives such as polymers (styrene-butadiene-styrene (SBS), styrene-butadiene rubber (SBR), etc.) and other technical stiffening agents. By producing a carbon coproduct 140 appropriate for use as an additive for asphalt bitumen that can replace a significant percentage of the mass of the asphalt bitumen in asphalt, the technology disclosed herein can economically sequester carbon removed from hydrocarbon fuels while helping improve various properties of asphalt pavement products.

That is, utilizing the solid carbon coproduct 140 as a portion of the asphalt binder can provide significant benefits to the production of the asphalt, as well as significant cost incentives for the pyrolysis system. For example, because the production cost of the solid carbon coproduct 140 is below that of asphalt bitumen, replacing a portion of the bitumen with the carbon coproduct 140 can reduce the overall cost of producing the asphalt. Additionally, or alternatively, similar to the discussion above, the CO₂ₑ of the carbon coproduct 140 can be below the CO₂ₑ of asphalt bitumen. As a result, replacing a portion of the bitumen with the carbon coproduct 140 can reduce the embodied emissions of the combined product.

Further, blending the carbon coproduct 140 into asphalt provides a way to sequester the solid carbon from the pyrolysis system for long durations. That is, integrating the carbon coproduct 140 can help prevent the carbon coproduct 140 from being released into the atmosphere as carbon dioxide (CO₂). Still further, asphalt production can be a distributed industry (e.g., asphalt can be produced in a large number of production facilities for local consumption rather than a few centralized facilities before being distributed). As a result, carbon coproducts 140 from distributed pyrolysis systems do not need to be shipped long distances to be integrated with asphalt production and/or do not require complex supply chains to link pyrolysis systems with the asphalt producers.

In some embodiments, as discussed further herein, the carbon coproduct 140 is capable of acting as a filler material to replace a significant portion of asphalt bitumen (for example, with tests showing positive results at about 5%, about 10%, about 20%, and about 30%). The added carbon coproduct may have positive effects, or only minor negative effects, on the Performance Grade (PG) and may not affect the production process or may confer some benefits to the production process. For example, for up to about 20% mass replacement with the carbon coproduct, the carbon coproduct can increase the bitumen viscosity less than 500 Centipoise (cP) at 135° C., well below a level which would require a change in processing conditions and/or equipment and/or would effect the long-term structural features of the resulting asphalt product. In some embodiments, the carbon coproduct addition can widen the acceptable operation temperature window for the pavement mixture by decreasing the high-temperature susceptibility of the materials during processing.

In some embodiments, the carbon coproduct 140 produced by the pyrolysis reactor, at addition levels of 5-20% by mass in unmodified asphalt, can increase the PG grade. The carbon coproduct, at addition levels of 5-20% by mass in Styrene Butadiene Styrene (SBS)-modified asphalt, may increase the PG grade by an even larger amount, in an exemplary instance. In some instances, there may be a favorable interaction between SBS and pyrolysis carbon (i.e., carbon coproduct 140). Because SBS is a high-cost additive, the carbon coproduct 140 may reduce the cost of modified asphalt by reducing the amount of SBS required to obtain the benefits of the modifications.

In some instances, even without adding SBS, the addition of carbon coproduct 140 can dramatically increase the rutting resistance of a binder to the point that it may approach the performance of a binder with SBS. This may further indicate that use of the carbon coproduct 140 in pavement may reduce the need for this expensive additive.

In some embodiments, asphalt workability (the number of gyrations required to reach 92% of maximum density) can be improved by the addition of carbon coproduct. In an example embodiment, the workability index may not be increased by more than 25% when decreasing the mixing temperature from 135° C. to 105° C., allowing the carbon coproduct to qualify as a warm mix additive in the asphalt production process. This may expand the potential applications of the carbon coproduct additive to asphalt (and related pavement products).

As discussed in more detail herein, the hydrogen gas produced by the pyrolysis system (i.e., hydrogen gas product 130) can be consumed by a variety of endpoints (i.e., can have a variety of endpoint uses 135). For example, the hydrogen gas product 130 can be combusted to supply heat to the asphalt manufacturing process. In some such embodiments, a ratio of outputs from the pyrolysis reactor can be tuned to match the mass and energy requirements of the asphalt production facility. In another example, the hydrogen gas product 130 can be combusted to provide heat for various other applications (e.g., a furnace, water boiler, water heater, power generation component, other manufacturing processes, and/or any other suitable application). In other embodiments, the hydrogen may be used to provide zero emission electricity through combustion in an engine or turbine, or through reaction in a fuel cell. In some such embodiments, the pyrolysis system is positioned local to the application for the hydrogen gas product 130, thereby avoiding a need to transport the hydrogen gas product 130. Instead, the carbon coproduct 140 can be collected and transported to an appropriate destination (e.g., an asphalt production facility).

In some embodiments, the pyrolysis systems disclosed herein can decarbonize two product streams (e.g., decarbonizing natural gas use by displacing natural gas with hydrogen gas product 130, and decarbonizing pavement and/or asphalt production) by using the carbon coproduct 140 from hydrogen production to replace portions of a blend used in another production (for example, pavement production). For example, the properties of the carbon coproduct 140 produced by the pyrolysis system can allow the carbon coproduct 140 to be blended with and used in asphalt products (and other pavement products) while the produced hydrogen is simultaneously decarbonizing the process heat in the same facility. In some embodiments, the pyrolysis system is implemented in an asphalt production facility.

In various embodiments, the pyrolysis system can be operated to create a variety of specific compositions for the carbon coproduct 140 based on the end use for the carbon coproduct 140. That is, the pyrolysis system can create various compositions of matter for the carbon coproduct 140 defining a family of modified binders (e.g., blends of carbon coproduct 140 with various asphalts and asphalt binders, including polymer-modified asphalts). As discussed in more detail herein, the modified binder can have a defined range of properties with listed asphalt mix designs and asphalt binders that can improve various performance metrics for the finished asphalt product.

In some embodiments, as will be discussed further herein, the pyrolysis system can be integrated with a pavement system (for example, an asphalt production system and/or asphalt binder blend system). In such embodiments, the pyrolysis system can reduce the overall CO₂ₑ of the system at two action points. First, as discussed above, the carbon coproduct 140 can replace materials in the asphalt (e.g., a portion of the bitumen) to reduce the CO₂ₑ of the finished product. Second, the hydrogen gas product 130 produced by the pyrolysis system can supplement (or replace) the natural gas consumed by the asphalt production system and/or the asphalt binder blend system to heat the asphalt blend during production. In some such embodiments, the pyrolysis system has a tuned H₂/C output ratio to match the heat and mass balance (HMB) needs of an asphalt plant and/or to decarbonize an asphalt plant, so that all produced carbon can be consumed on-site, and no additional distribution or transport is required.

Although primarily discussed herein as systems and methods for sequestering carbon from natural gas pyrolysis for use in an asphalt product, one of skill in the art will understand that the scope of the technology is not so limited. For example, the pyrolysis process/reaction 100 can also be controlled to produce carbon (i.e., carbon coproduct 140) suitable for various other carbon-containing products and/or endpoint uses 145, such as various other pavements, batteries, plastics, thermoplastics, carbon fiber products, and/or various other suitable materials. In another example, the carbon integrated with the asphalt process can result from various other carbon-generating processes, such as pyrolysis of other hydrocarbons, other carbon-capture technologies, and/or any other suitable process. Accordingly, the scope of the technology is not confined to any subset of embodiments discussed herein.

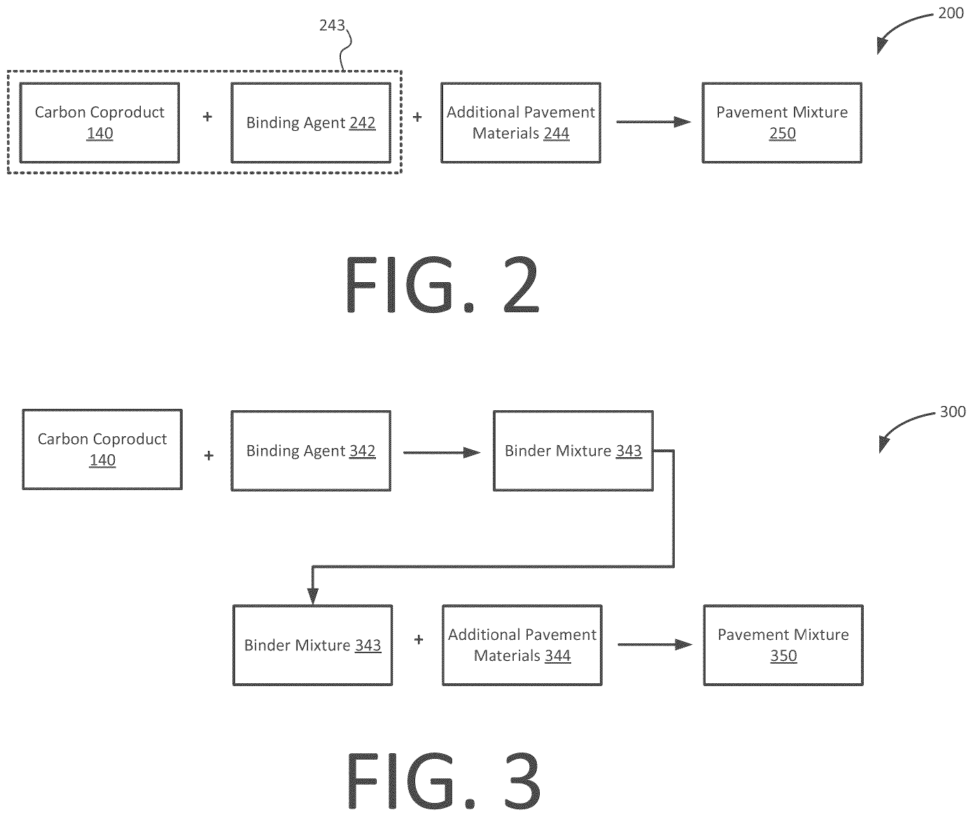

FIGS. 2 and 3 illustrate example applications/uses 200 and 300 (respectively) of the carbon coproduct 140 from the pyrolysis reaction 100, according to an embodiment. As discussed herein, the carbon coproduct 140 has advantageous properties for various pavement applications and, as such, can be used in a pavement mixture. For example, in some instances, the carbon coproduct 140 can displace a portion of binding agent and can be used (in some instances, along with the binding agent) in a binder mixture. This binder mixture, in some embodiments, can be used in a pavement mixture. In some embodiments, as discussed herein, the pavement mixture can be asphalt and/or the binding agent can be bitumen.

In some embodiments, producing a pavement product/mixture (such as an asphalt product) with the carbon coproduct 140 includes blending the carbon coproduct in a pavement mixing process as an additive. The asphalt mix can then be deployed as normal. FIG. 2 depicts producing a pavement mixture 250 with the carbon coproduct 140 as an additive. For example, as depicted in FIG. 2, the carbon coproduct 140, a binding agent 240 (for example, bitumen), and additional pavement materials 244 can all be added together to form a pavement mixture 250 (for example, asphalt, cement, concrete, etc.). In some embodiments, as discussed further herein, the carbon coproduct 140 and the binding agent 242 can together be referred to as a binder mixture 243. In some embodiments (for example, when the pavement mixture 250 is asphalt), the additional pavement materials 244 can be aggregates (for example, mineral materials such as sand, gravel, stone, etc.).

In some instances, the carbon coproduct 140 can be dosed into a pavement mixing plant using a solids handling system. In some embodiments, the process of forming a pavement mixture 250 using carbon coproduct 140 as an additive can include 1) heating aggregates to appropriate mixing temperature in drying drum while simultaneously heating a traditional asphalt binder; 2) moving aggregates into a mixing drum; 3) adding the carbon coproduct and the traditional asphalt binder into the mixing drum; 4) agitating the mixture until homogeneous; and 5) emptying the mixing drum into a truck for transport or silo for storage.

In some embodiments, instead of the carbon coproduct 140 being blended in as an additive, the carbon coproduct 140 can be pre-blended into the binding agent. This is depicted in FIG. 3. Specifically, FIG. 3 depicts the carbon coproduct 140 and a binding agent 342 being pre-blended to form a binder mixture 343. The binder mixture 343 can then be mixed with additional pavement materials 344 to form a pavement mixture 350. The binder mixture 343 includes the carbon coproduct 140 and the binding agent 342. In some embodiments, as discussed herein, the carbon coproduct 140 can be sequestered in the binder mixture, thus helping reduce the amount of carbon being released into the atmosphere. In an exemplary embodiment, the binding agent 342 can be bitumen and the additional pavement materials 344 can be aggregates. In this example, the pavement mixture 350 can include the binder mixture 343 (with carbon coproduct 140 and bitumen) and aggregates.

In some embodiments, when the carbon coproduct 140 is pre-blended into the binding agent 342 (such as asphalt binder, for example), the process of forming the pavement mixture 350 can include 1) heating the asphalt binder; 2) moving binder into low-shear mixing silo; 3) adding the carbon coproduct into the shear mixing silo; 4) agitating until homogeneous; and 5) emptying the mixing drum into a truck for transport or silo for storage before being added to other ingredients of a pavement product (for example, using any applicable process).

In some embodiments, a binder mixture 243, 343 (i.e., a mixture of carbon coproduct 140 and binding agent (242 and/or 342)) can include about 70-95% by mass of binding agent (e.g., asphalt bitumen, etc.) and 5-30% by mass of carbon coproduct 140. Example binding agent (242, 342) types can include unmodified asphalt binders with performances following the PG grading system where PG-HH-CC defines the hot (HH) and cold (CC) limits: HH between (not inclusive) about 50 and about 64 degrees; CC between (not inclusive) about 16 and about 40 degrees. Another example binding agent (242, 342) type can include polymer-modified asphalt binders including SBS, where the amount of added SBS is between 0 and 5% by mass, with performances following the PG grading system where PG-HH-CC defines the hot (HH) and cold (CC) limits: HH between (not inclusive) about 64 and about 80 degrees; CC between (not inclusive) about 16 and about 40. degrees Therefore, in some embodiments, less than or equal to 30% of the binder mixture 243, 343 is carbon coproduct 140.

In some embodiments, a pavement mixture 250, 350 (e.g., asphalt) can include 4-7.6% by mass of binding agent 242, 342 (e.g., asphalt bitumen) of which 0.25-10% by mass is comprised of carbon coproduct 140, and 92-95% by mass of additional pavement materials 344 (e.g., aggregate, gravel, sand, and/or dust). In some embodiments, less than or equal to 15% of the pavement mixture 250, 350 is the binder mixture 243, 343. Further, as discussed herein, the carbon coproduct 140 can take up to 30% of the 15% pavement mixture as a maximum of total mass displaced in a full mix design. In some embodiments, the carbon coproduct 140 can be used as a binding agent replacement (for example, used in the binder mixture 243, 343) in hot mix or warm mix asphalt. Put differently, the pavement mixture 250, 350 can be a hot mix or a warm mix, in some instances. The carbon coproduct 140 can replace up to 5%, up to 10%, up to 15%, up to 20%, or up to 25+% of the bitumen fraction in an asphalt mix.

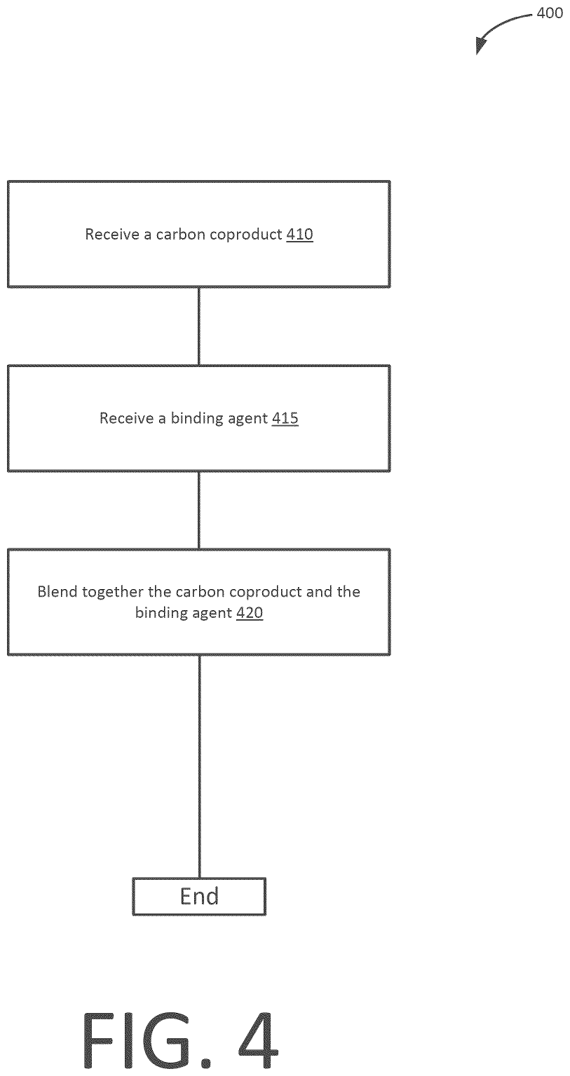

FIG. 4 illustrates an example method 400 of producing a pavement mixture, according to an embodiment. In some embodiments, method 400 can be a method of producing pavement mixture 250 and/or pavement mixture 350. Method 400 can include operation 410 to receive a carbon coproduct. As discussed herein, the carbon coproduct (such as carbon coproduct 140) can be a coproduct from a pyrolysis reaction. In some embodiments, as discussed herein, the carbon coproduct can be transported and/or shipped from a pyrolysis system/plant to a pavement system/plant. In some embodiments, the pyrolysis system and pavement system may be within a same plant, therefore the carbon coproduct may already be within a pavement plant/system.

Method 400 can include operation 415 to receive a binding agent. A binding agent may be a material, mixture, etc. that helps bind together various components. For example, in some embodiments, the pavement mixture may be asphalt and the binding agent may be bitumen. In pavement mixtures such as asphalt, the bitumen may bind and hold together the various aggregate materials (e.g., stone, sand, gravel, etc.). In some embodiments, method 400 can include pyrolyzing a hydrocarbon feedstock to produce the carbon coproduct and the hydrogen gas, wherein the carbon coproduct is received from a pyrolysis reactor. In some embodiments, the carbon coproduct is tailored to have characteristics (for example, particle size, particle morphology, particle allotrope, purity, hydrophobicity, and/or oil content) that improve properties of the binder mixture, as discussed herein. In some embodiments, the binding agent (for example, bitumen) may need to be heated and/or otherwise prepared prior to being blended and/or mixed with other components. In some instances, the binding agent can be pre-heated prior to being received. In some instances, the binding agent can be heated after it is received but prior to being blended/mixed. In some instances, the binding agent may not need to be heated prior to being blended and/or mixed with other components. Preparing the binding agent (for example, heating the binding agent) may help the binding agent better blend/mix with the other components. In some embodiments, preparing the binding agent (for example, heating the binding agent) can be at least partially fueled/powered from at least a portion of hydrogen gas from the pyrolysis reaction.

Method 400 can include operation 420 to blend together the carbon coproduct and the binding agent. In some embodiments, blending together the carbon coproduct and the binding agent can result in a binder mixture (e.g., binder mixture 243 and/or 343). In some embodiments, blending together the carbon coproduct and the binding agent can be at least partially fueled/powered from at least a portion of hydrogen gas from the pyrolysis reaction. For example, the hydrogen gas can be used to heat the carbon coproduct and/or the binding agent, to power one or more pieces of equipment for blending the carbon coproduct and the binding agent, etc. As discussed herein, there are instances where the carbon coproduct is pre-blended into the binding agent. Put differently, a binder mixture (i.e., the mixture of the carbon coproduct and the binding agent) may be pre-formed and/or pre-blended. Therefore, in these instances, method 400 can include subsequently mixing the binder mixture with additional pavement materials.

As an example embodiment, in instances where the carbon coproduct and the binding agent are pre-blended to form the binder mixture, preparing the binding agent can include heating the binding agent; and blending together the carbon coproduct and the binding agent can include moving the binding agent into a low-shear mixing silo, adding the carbon coproduct into the low-shear mixing silo, and agitating the binding agent and the carbon coproduct until homogeneous, resulting in the binder mixture. For example, when the pavement mixture is asphalt and the carbon coproduct is pre-blended, producing an asphalt mixture can include heating the asphalt binder; moving binder into low-shear mixing silo; adding the carbon coproduct into the shear mixing silo; agitating until homogeneous; and emptying the mixing drum into a truck for transport or silo for storage before being added to other ingredients of a pavement product according to a conventional process.

In some embodiments, as discussed herein, carbon coproduct can be an additive when producing a pavement mixture. In these embodiments, method 400 can include receiving one or more pavement materials (for example, aggregates) and preparing the one or more pavement materials (for example, heating the materials). Then, the one or more pavement materials, the carbon coproduct, and the binding agent may be blended together.

In some embodiments, preparing the one or more pavement materials can include heating the one or more pavement materials; preparing the binding agent can include heating the binding agent; and blending together the one or more pavement materials, the carbon coproduct, and the binding agent can include adding the one or more pavement materials to a mixing drum, adding the binding agent and the carbon coproduct to the mixing drum, and agitating the one or more pavement materials, the binding agent, and the carbon coproduct until homogeneous, resulting in the pavement mixture. For example, when the pavement mixture is asphalt and the carbon coproduct is an additive, producing an asphalt mixture can include heating aggregates to appropriate mixing temperature in drying drum while simultaneously heating a traditional asphalt binder; moving aggregates into a mixing drum; adding the carbon coproduct and the traditional asphalt binder into the mixing drum; agitating the mixture until homogeneous; and emptying the mixing drum into a truck for transport or silo for storage. Therefore, in some embodiments, heating the one or more pavement materials and the heating the binding agent can be simultaneous.

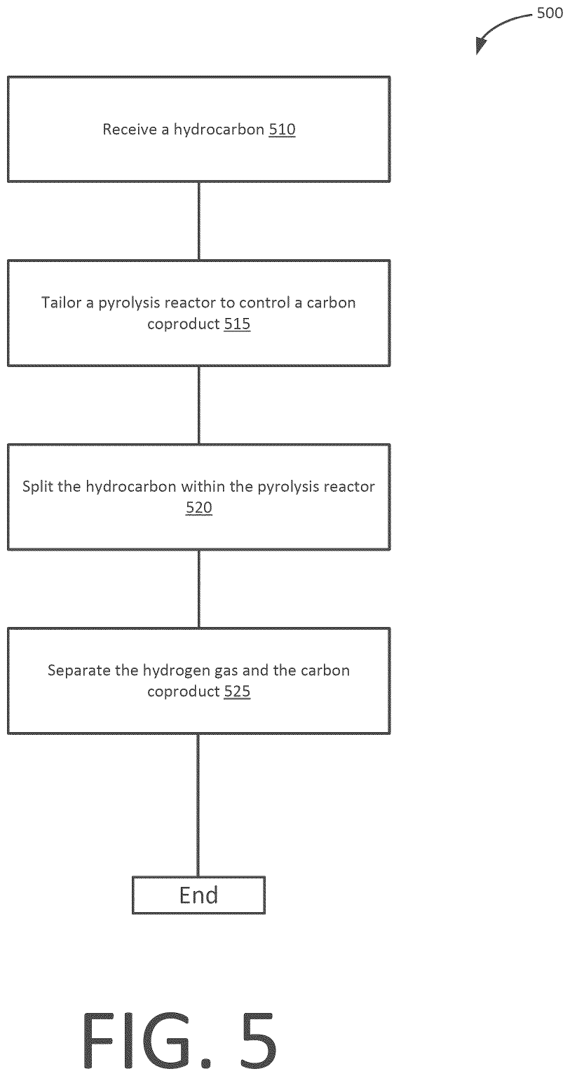

FIG. 5 illustrates an example method 500 of producing a carbon coproduct such as carbon coproduct 140, according to an embodiment. Method 500 may produce a carbon coproduct via a pyrolysis reaction.

Method 500 can include operation 510 to receive a hydrocarbon. The hydrocarbon can be hydrocarbon 110, in some embodiments, and can include one or more hydrocarbons. Hydrocarbons can include natural gas, pure methane, and/or other suitable hydrocarbons.

Method 500 can include operation 515 to tailor a pyrolysis reactor to control a carbon coproduct. In some embodiments, a pyrolysis system can be controlled/tailored to produce a carbon coproduct with characteristics that are suitable for supplementing binders/binding agents in asphalt products and/or other pavement products. Characteristics of the composition/physical forms of carbon suitable for supplementing binders in asphalt products (and/or other pavement products) include; iodine absorption—between about 1 mL/100 g and about 30 mL/100 g, or of about 12.3 mL/100 g; oil absorption—between about 20 cm³/100 g and about 100 cm³/100 g, or of about 58.7 cm³/100 g; N₂ surface area—between about 1 m²/g and about 100 m²/g, or of about 8.6 m²/g; average primary particle size-between about 50 nm and about 10000 nm, or about 124.62 nm; and/or oil content between about 0 and about 25% by mass, or between about 1% and about 6% by mass. In some embodiments, the oil can contain organic compound byproducts (e.g., pyrolysis oil; asphaltenes; acetylene; carbon monoxide; carbon dioxide; water vapor; organic compounds such as volatile organic compounds (VOCs) (e.g., hexane, propane, butane, butadiene, toluene, benzene, trimethylbenzene, ethanol, formaldehyde, naphthalene) and/or semi-volatile organic compounds (SVOCs) (e.g., decane, fluorene, dibenzofuran, chrysene, pyrene, fluoranthene, octadecane, phenanthrene, anthracene, naphthalene, caprolactam, and/or the like); other oils; waxes; and/or the like). Therefore, in some embodiments, tailoring the pyrolysis reactor controls at least one of a particle size, purity, hydrophobicity, and/or oil content of the carbon coproduct.

Carbon coproducts with these characteristics can be produced by a variety of systems. In a specific example, as discussed in more detail below, a pyrolysis system can be controlled to produce a carbon coproduct with these characteristics. However, it will be understood that carbon having the characteristics described above can be produced by other processes and integrated with the compositions described herein.

As discussed above, pyrolysis systems split hydrocarbons (e.g., natural gas, methane, renewable natural gas, and/or any other suitable hydrocarbon) into a hydrogen gas coproduct and a solid carbon coproduct. The pyrolysis system can be controlled to produce the carbon coproduct for use in mixtures as an additive for asphalt products. In a specific non-limiting example, a pyrolysis system can split natural gas into hydrogen gas and a solid carbon that is optimized for and compatible with bitumen. For example, the pyrolysis reaction can have a controllable temperature profile and residence time which can produce particles of carbon (i.e., carbon coproduct) that are tailored, controlled, customized, and/or otherwise suitable for supplementing binders/binding agents in asphalt products and/or other pavement products. Pyrolysis reactors can include other methods of modifying the reaction kinetics, including the addition of catalysts and energy and/or chemical radicals from plasma sources. Pyrolysis reactors can include small amounts of additional reactants (oxygen, air, steam, CO₂, halogens) which serve to alter the surface chemistry of produced particles in a facile way without significantly impeding the overall pyrolysis process.

In some embodiments, the pyrolysis reaction also produces some amount of oils and hydrocarbons. The pyrolysis reactor can, in some instances, be tailored so that the reaction products (e.g., the carbon coproduct) has an oil/hydrocarbon range of 0-25%. This oil/hydrocarbon can contain organic compound byproducts (e.g., pyrolysis oil; asphaltenes; acetylene; carbon monoxide; carbon dioxide; water vapor; organic compounds such as volatile organic compounds (VOCs) (e.g., hexane, propane, butane, butadiene, toluene, trimethylbenzene, ethanol, naphthalene) and/or semi-volatile organic compounds (SVOCs) (e.g., decane, fluorene, dibenzofuran, chrysene, pyrene, fluoranthene, octadecane, anthracene, naphthalene, caprolactum, and/or the like); other oils; waxes; and/or the like).

As a result, the carbon coproduct can be sequestered in an asphalt product without negatively impacting the various properties of the asphalt product, including its mechanical properties, chemical properties, ability to be processed and applied, and the varieties of environmental conditions compatible with nominal performance. For example, the carbon particles and oils or hydrocarbons can emerge from the pyrolysis system separately, as a mixture, and/or as a combination of mixtures and pure components. In some embodiments, the oils are the products from the pyrolysis reaction other than the solid carbon and the hydrogen gas. When combined, the carbon particles and oils can produce a mixed solids product that is referred to as the carbon coproduct of the pyrolysis reaction. Therefore, in some embodiments, the carbon coproduct can be a mixture of carbon particles and oils, resulting in a mixed solids carbon coproduct. As discussed herein, the carbon coproduct can be deliberately engineered/controlled to be compatible and miscible with bitumen, by tailoring the reactor and adjusting, for example, the average reactor temperature, reactor temperature profile, flowrate of feedstock into the reactor, flowrate of combustion fuel to the reactor, reactor residence time, feedstock composition (for example, by mixing a portion of the reactor product gas, or an inert gas, or a gas containing an oxidizer with the feedstock before it enters the reactor, or by capturing and re-injecting produced heavier hydrocarbons and oils as feedstock), the Reynolds number of the reactor, the use of a catalyst in some part of the reactor, or the addition of other energy types (such as electromagnetic energy) to the reactor. As an example, using catalysts can modify the morphology and allotrope of produced carbon particles, creating more crystalline domains, graphene nanoparticle, or carbon nanotubes. As another example, the use of electromagnetic energy (such as from a plasma source) can allow rapid heating and quenching of the reaction, producing smaller particles. Utilizing methane as the feedstock for pyrolysis can increase the particle purity relative to carbon particle production with heavier oil feedstocks.

Therefore, in some embodiments, tailoring a pyrolysis reactor to control a carbon coproduct (i.e., operation 515 of method 500) can include adjusting one or more factors of the pyrolysis reactor. In some embodiments, as discussed herein, the one or more factors can include at least one of average reactor temperature, reactor temperature profile, flowrate of feedstock into the pyrolysis reactor, flowrate of fuel to the pyrolysis reactor, reactor residence time, feedstock composition, Reynolds number of the pyrolysis reactor, a use of a catalyst in a part of the pyrolysis reactor, and an addition of another energy type to the pyrolysis reactor.

Method 500 can include operation 520 to split the hydrocarbon within the pyrolysis reactor. In some embodiments, splitting the hydrocarbon includes chemically degrading the hydrocarbon (for example, by heating the hydrocarbon, in some instances). As discussed herein, a pyrolysis reactor can heat hydrocarbon(s) to an extremely high temperature (i.e., the reaction temperature), and at this extremely high temperature, the hydrocarbon(s) are heated above their decomposition temperature, which can break chemical bonds in its molecules and convert the hydrocarbon(s) into hydrogen gas and carbon. Therefore, in some embodiments, at the reaction temperature at least a portion of the hydrocarbon converts into hydrogen gas and the controlled carbon coproduct. In some embodiments, integration of a catalyst in the pyrolysis reactor reduces the required temperature.

Method 500 can include operation 525 to separate the hydrogen gas and the carbon coproduct. Once the pyrolysis reaction has occurred, a product stream of carbon coproduct and hydrogen gas can be outputted from the pyrolysis reactor, and then the hydrogen gas and carbon coproduct may be separated from each other. As discussed herein, there are various uses for each product. For example, the hydrogen gas can be used to help heat the pyrolysis reactor, can be used to provide heat for various other applications, etc. In some instances, at least a portion of the hydrogen gas can produce electricity with various other device(s). For example, power generator(s) can use the hydrogen gas to generate electricity. In various exemplary embodiments, the power generator(s) can include a thermionic converter, a thermophotovoltaic system, an alkali metal thermal energy converter (AMTEC), a fuel cell, an internal combustion engine, a turbine or microturbines, a thermoelectric generator, a steam turbine, and/or a Stirling engine. The carbon coproduct, in some instances, can be used in a binder mixture which can, as an example, be a part of pavement.

In some embodiments, for example due to the tailoring of the pyrolysis reactor, the carbon coproduct can be tailored for a binder mixture. In some instances, the carbon coproduct can be controlled/tailored after the pyrolysis reaction has occurred. For example, either additionally or alternatively to the pyrolysis reactor tailoring, the pyrolysis system can remove the carbon coproduct from the product stream immediately following the reaction chamber (e.g., to remove carbon coproduct with a relatively high oil content) and/or after running the product stream through one or more post-production filters (e.g., thereby removing at least a portion of the oil in the product stream and lowering the oil content of the carbon coproduct). As a result, the particle size, purity, hydrophobicity, and/or oil content of the carbon coproduct can be controlled, thereby allowing the pyrolysis process to reduce (or minimize) the impact of the carbon coproduct on the viscosity of the bitumen. In turn, the control allows the pyrolysis process to reduce (or minimize) the carbon coproduct's impact on the performance of the bitumen as a binder. The control can also maximize any positive benefits of the carbon on the properties of the asphalt mixture. Therefore, in some embodiments, separating the hydrogen gas and the carbon coproduct can include immediately removing the carbon coproduct from a product stream of the pyrolysis reactor. In some embodiments, separating the hydrogen gas and the carbon coproduct can include running a product stream of the pyrolysis reactor, the product stream including the hydrogen gas and the carbon coproduct, through one or more post-production filters.

As discussed herein, the carbon coproduct can be used as a bitumen replacement in hot mix or warm mix asphalt. The carbon coproduct can replace up to 5%, up to 10%, up to 15%, up to 20%, or up to 25+% of the bitumen in a typical asphalt mix design. In some embodiments, the carbon coproduct may be added to an asphalt mixture as an unmodified powder. In some embodiments, the carbon coproduct may be pelletized. The oils produced by the pyrolysis reactor may be used as a pelletizing binder/agent. As an example, the carbon coproduct can be mixed directly into bitumen using typical processing equipment, such as a pug mill. Various properties of the carbon coproduct (e.g., the purity, hydrophobicity, and/or its oil content) lead to a reduction in the carbon coproduct's impact on the bitumen viscosity as compared to other bitumen replacements. This solves a common problem with fine additives to bitumen. The mixed carbon coproduct serves an additional function as a carbon sequestration vehicle because the carbon coproduct was produced in a process that removes carbon from natural gas. Solid carbon is inert when stored in the asphalt matrix, leading to long-duration sequestration.

Indeed, the carbon coproduct can improve various metrics of the asphalt's performance, which can include its mechanical properties, chemical properties, ability to be processed and applied, and the varieties of environmental conditions compatible with nominal performance. For example, the mixed carbon coproduct can improve the high-temperature performance of the bitumen by stiffening it without excessive detriment to the cold-temperature performance. The bitumen can have more resistance to deformation and softening. In practice, this means that the upper limit temperature is increased by a magnitude greater than the amount the lower limit temperature is increased, leading to a wider window of temperatures in which the asphalt may be used. In other cases, the cold-temperature performance is unaltered entirely, or potentially also improved.

In some embodiments, the carbon coproduct can improve the workability of the asphalt mixture, resulting in fewer voids in fewer mixing cycles. The carbon coproduct can affect the workability positively, in which case it is usable as an additive to warm mix asphalt. The addition of the carbon coproduct can improve the rutting resistance of the asphalt mixture as measured by a test such as the Hamburg wheel test. In some cases, the addition of the carbon coproduct reduces the overall carbon intensity of the bitumen/carbon mixture, because the carbon intensity of the added carbon coproduct is lower than the bitumen. This can be true for the case where all emissions from the pyrolysis reactor are assigned to the hydrogen, or for other methods of allocation, such as by mass, energy value, or economic value.

In the case of polymer-modified asphalt (where SBS is the polymer additive), the traffic grading performance may be disproportionately improved by the mixed carbon coproduct additive, allowing the reduction of SBS additive use for the same level of performance benefit. An increase in oil content in the carbon coproduct produced may reduce the amount of viscosity modifiers such as naphtha that can be added in the formulation of the asphalt mix. In effect, the presence of an optimal concentration of oil in carbon can eliminate the need to add an external viscosity modifier in the process.

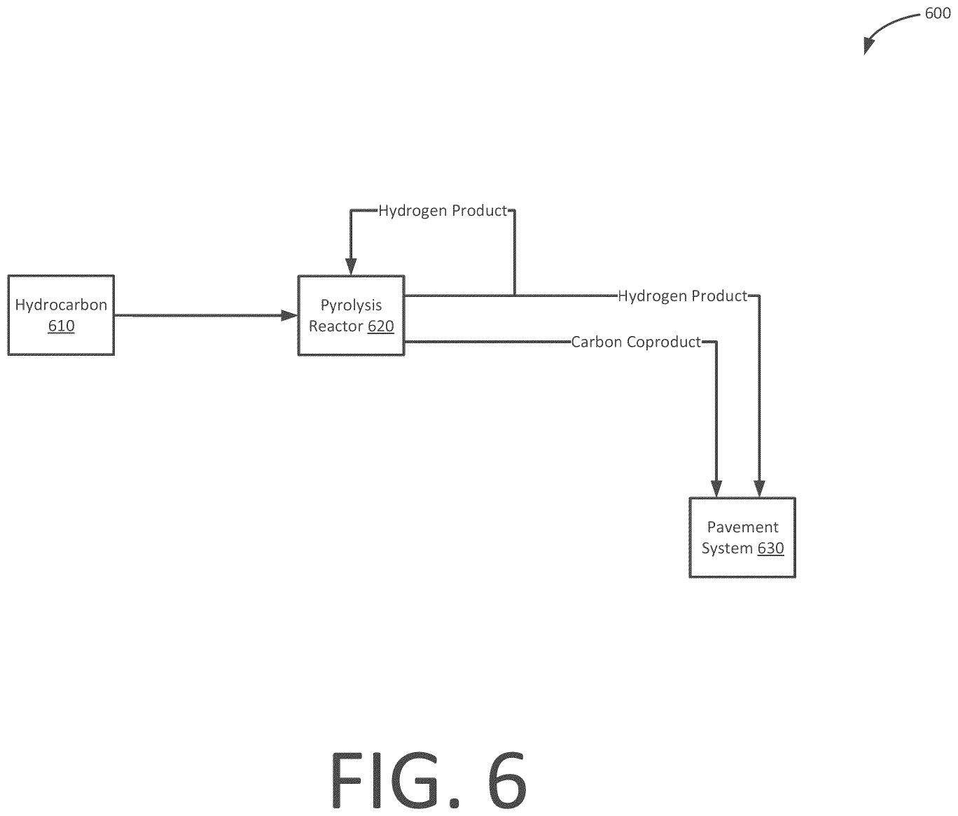

FIG. 6 illustrates an example system 600 for producing pavement, according to an embodiment. In some embodiments, as depicted in FIG. 6, the system 600 can include a pyrolysis reactor 620 and a pavement system 630. The pyrolysis reactor 620 can heat hydrocarbon(s) 610, resulting in a hydrogen gas product and a carbon coproduct. The pavement system 630 can, in some embodiments, form a pavement mixture that comprises the carbon coproduct produced from the pyrolysis reactor 620. In some embodiments, as depicted in FIG. 6, at least a portion of the hydrogen gas product from the pyrolysis reactor 620 can be recycled to power the pyrolysis reactor 620.

In some embodiments, the pyrolysis reactor 620 and the pavement system 630 may be within different facilities, and the carbon coproduct can be transported to the pavement system 630. In some embodiments, the pyrolysis reactor 620 and the pavement system 630 may be within a same facility. In some instances, for example when the pyrolysis reactor 620 and the pavement system 630 are within a same facility, a portion of the hydrogen gas product from the pyrolysis reactor 620 can go to the pavement system 630 and can be recycled to power one or more components of the pavement system 630. In some embodiments, the carbon coproduct can be continuously fed into the pavement system 630. As an example, the pavement system 630 can produce at least one of pavement binder, asphalt, cement, concrete, etc. In some embodiments, for example, when the pyrolysis reactor 620 and the pavement system 630 are a combined system/facility, a pyrolysis reactor 620 is tailored to produce carbon coproduct with characteristics that are suitable for a pavement mixture, one or more portions of hydrogen gas are used to power one or more components of the pavement system, and the carbon coproduct replaces a portion of binding agent in the pavement mixture.

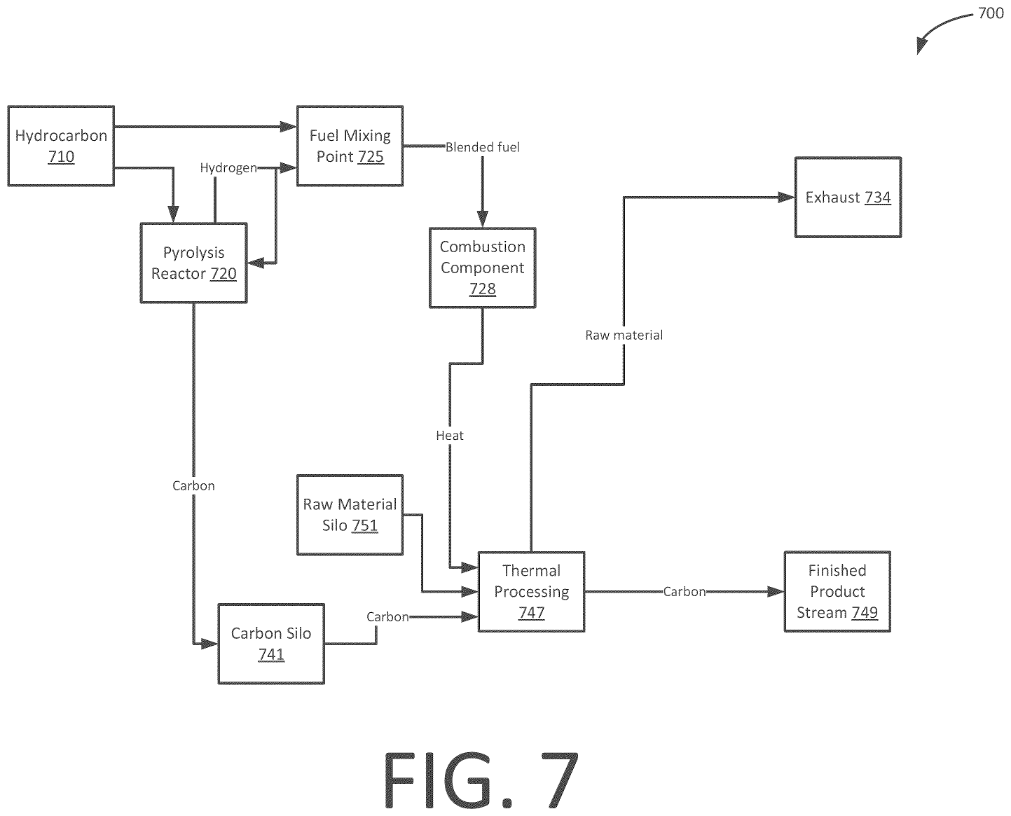

A facility with both a pyrolysis reactor and a second system (for example, a pavement system) can be referred to herein as a combined system and/or a pyrolysis combined system. FIG. 7 illustrates an example pyrolysis combined system 700, according to an embodiment. Combined system 700 is just one exemplary system of how a pyrolysis reactor/system and another system can be combined and can utilize the various products of the various components of the combined system 700.

In combined system 700, a pyrolysis reactor 720 performs pyrolysis of a hydrocarbon 710 (e.g., natural gas, methane, mixed hydrocarbons, etc.) to form carbon coproduct and hydrogen gas product. In some embodiments, the hydrogen gas product can include H₂, unreacted feed, byproducts, etc. In exemplary system 700, a portion of the hydrogen gas product goes to a fuel mixing point 725 and a portion is recycled and used to heat the pyrolysis reactor 720. In some embodiments, some hydrocarbon 710 can be fed to the fuel mixing point 725 (along with the hydrogen gas product) to mix and form a blended fuel. The blended fuel can go through a combustion component 728 to form heat that can be used to heat various components of the system 700. In some embodiments, at least a portion of the hydrogen gas product is used for electricity production (for example, through fuel cells and/or other devices).

In some embodiments, the carbon coproduct from the pyrolysis reactor 720 can be stored in a carbon silo 741. In some embodiments, carbon coproduct from a carbon silo 741 and raw material from a raw material silo 751 can go through thermal processing 747 (using the heat from the combustion component 728), resulting in raw material exhaust 734 and a finished product stream 749 with carbon coproduct.

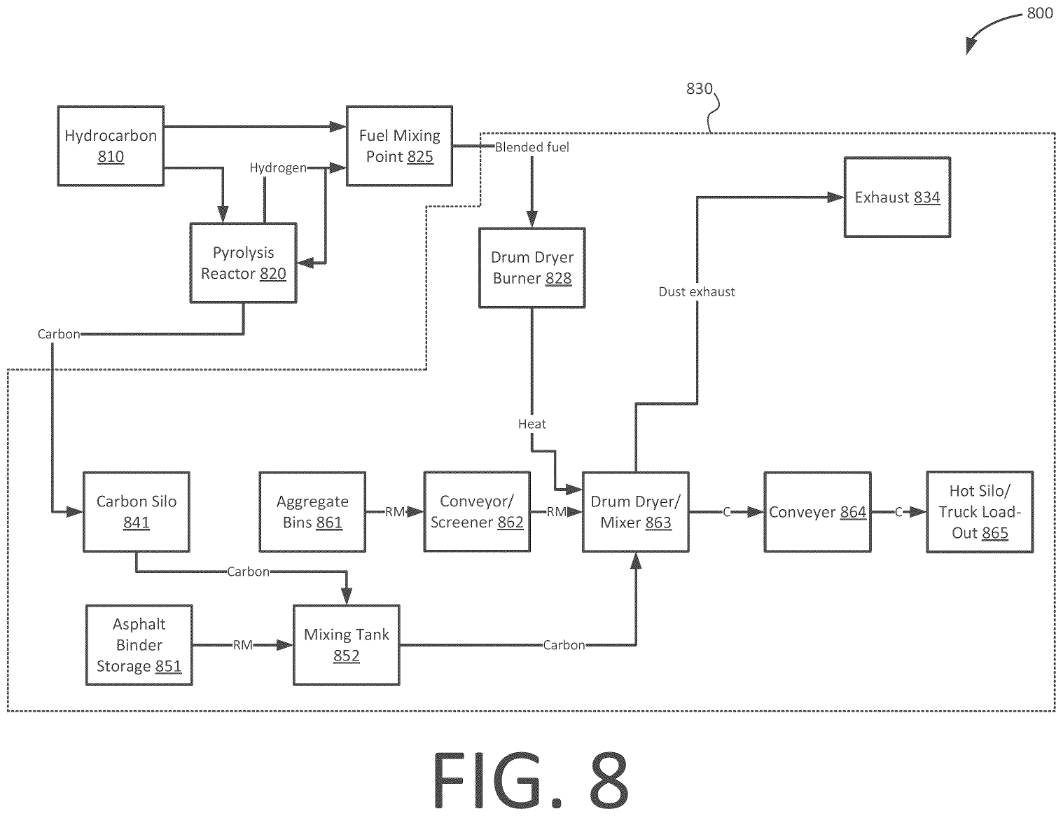

FIG. 8 illustrates an example asphalt combined system 800, according to an embodiment. In some embodiments, a pyrolysis reactor is installed at and integrated with an asphalt production facility. The combined pyrolysis reactor and asphalt production facility (sometimes referred to herein as a “combined pyrolysis and asphalt plant”) can capture efficiencies between aspects of the present technology. For example, the pyrolysis reactor can have a tunable ratio of hydrogen: carbon coproduct produced (e.g., by recycling varying amounts of the product hydrogen to combust to power the reactor). That is, the pyrolysis reactor can use a combination of a hydrocarbon (e.g., methane, natural gas, hydrocarbon gas, a mixture of hydrocarbon gases, or other hydrocarbons (liquids, solids, gases, or mixtures of these)) with a first portion of the resulting hydrogen gas to provide energy for the pyrolysis reaction. A second portion of the resulting hydrogen gas, in turn, can be used as fuel for various other components of the combined pyrolysis and asphalt plant (e.g., to combust and provide heat to a mixing chamber for the asphalt constituents, to generate electricity (e.g., using a power generator, a thermionic converter, a thermophotovoltaic system, an AMTEC, a fuel cell, an internal combustion engine, a turbine or microturbines, a thermoelectric generator, a steam turbine, and/or a Stirling engine) to power one or more components of the combined pyrolysis and asphalt plant, etc.).

In some embodiments, the production facility (i.e., the combined plant) can produce bitumen, hot mix asphalt, or warm mix asphalt. More generally, the facility can produce a variety of products with components that can be partially substituted and/or improved by the addition of the carbon coproduct and/or that require the use of a fuel stream (e.g., for process heating or chemical processing). The material stream can include asphalt, cement, rubber, batteries, plastics, thermoplastics, and/or various other suitable materials.

In some embodiments, the pyrolysis reactor can be sized and designed to be compatible with the asphalt production facility while helping decarbonize the asphalt production facility. For example, typically, in the production of hot mix asphalt, bitumen is heated to an elevated temperature via combustion of fossil fuels. This process requires a certain heating power per unit mass of asphalt. The pyrolysis reactor can produce enough hydrogen to replace the heating source, while the carbon coproduct produced in the pyrolysis reactor can be used as an additive to the product. Furthermore, the pyrolysis reactor can be tuned such that the amount of carbon produced is optimally compatible with the asphalt mix design produced. Alternatively, the pyrolysis reactor can be operated to produce a different amount of carbon coproduct, with the excess supplying other processes. More generally, the scaled operation of the pyrolysis reactor can also apply to other material streams and facilities, where the desirable hydrogen-to-carbon coproduct mass ratio, as well as pyrolysis reactor size, may be different.

For example, the combined pyrolysis and asphalt plant could include any suitable number of pyrolysis reactors powering a heated drum mixer while producing up to 5%, up to 10%, up to 15%, up to 20%, or up to 25% by mass of the continuous feed rate of bitumen as carbon coproduct. As another example, the combined pyrolysis and asphalt plant could include any suitable number of pyrolysis reactors powering a heated cement kiln while producing up to 5%, up to 10%, up to 15%, up to 20%, or up to 25% of the continuous feed rate of cement as carbon coproduct.

In some embodiments, the carbon coproduct can be continuously or batch-fed into the asphalt plant to act as a bitumen extender, reducing costs while improving performance and reducing the emissions of the entire asphalt plant. Further, the operating conditions of the pyrolysis reactor (e.g., reaction temperature, operating temperature, flowrate, residence time, ratio of output gas recycled into the feed stream, composition of feedstock, use of a catalyst, an addition of other energy types (such as from a plasma source), an addition of chemical radicals (such as from a plasma source), etc.) can be adjusted to control various physical properties of the carbon coproduct (such as the properties described above with reference to the characteristics of the composition/Physical forms of carbon coproduct) in the interest of making the carbon coproduct more compatible with the asphalt product.

Combined system 800 illustrates example components of a combined pyrolysis/asphalt plant. For example, in system 800, hydrocarbon 810 is fed into a pyrolysis reactor 820 and a fuel mixing point 825. The pyrolysis reactor 820 produces a hydrogen gas product and a carbon coproduct (which can be stored in carbon silo 841). In some embodiments, a portion of the hydrogen gas is used to heat the pyrolysis reactor 820, a portion of the hydrogen gas is used to produce electricity (for example, to be used with one or more of the combined system 800 components (such as components 828, 852, 862, 863, 864, and/or any other component)), and/or a portion is mixed with hydrocarbon 810 at the fuel mixing point 825 to form a blended fuel (which can proceed to a drum dryer burner 828 to form heat).

In some embodiments, the carbon coproduct can be mixed with raw material (from asphalt binder storage 851) at mixing tank 852. As discussed herein, an example raw material from asphalt binder storage 851 is bitumen. Therefore, in some instances, mixing tank 852 is an asphalt bitumen mixing tank. In some embodiments, raw material (e.g., aggregates) goes from aggregate bins 861 to conveyor/screener 862, and is then mixed with the carbon coproduct mixture (from the mixing tank 852) at the drum dryer/mixer 863 (using heat from the drum dryer burner 828). The drum dryer/mixer 863 can form an asphalt mixture (that includes the carbon coproduct) and dust exhaust (i.e., exhaust 834). The asphalt mixture can go through conveyer 864 and to a truck for load-out (e.g., hot silo/truck load-out 865). In some embodiments, as depicted in FIG. 8, a combined system can include a pyrolysis reactor 820 and a pavement system 830, which in this case is an asphalt system 830.

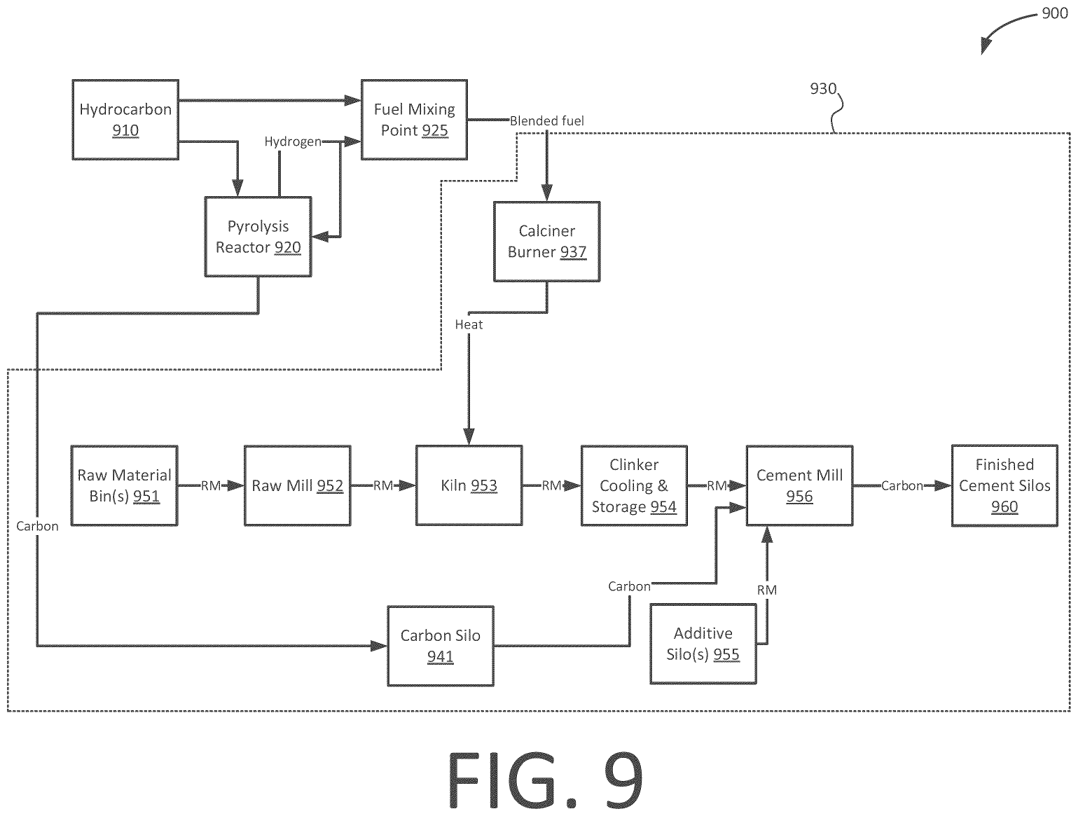

As discussed herein, another example pavement type is cement. Therefore, in some instances, a pyrolysis reactor can be combined with a cement plant. FIG. 9 illustrates one such example cement combined system 900, according to an embodiment. The cement combined system 900 can include a pyrolysis reactor 920 and a cement system 930. Similar to the other exemplary combined systems 700 and 800, hydrocarbon 910 is fed into a pyrolysis reactor 920 and a fuel mixing point 925. The pyrolysis reactor 920 produces a hydrogen gas product and a carbon coproduct (which can be stored in carbon silo 941). In some embodiments, a portion of the hydrogen gas is used to provide energy to the pyrolysis reaction (either through heat via combustion or through electric energy via an engine, turbine, or fuel cell) within the pyrolysis reactor 920 and a portion is mixed with hydrocarbon 910 at the fuel mixing point 925 to form a blended fuel (which can proceed to a calciner burner 937 to form heat).

In some embodiments, as depicted in FIG. 9, system 900 can include raw material bin(s) 951 storing raw material. The raw material can proceed to a raw mill 952 and then to a kiln 953, which can use heat from the calciner burner 937. The raw material can then go to clinker cooling and storage 954, and can then proceed to a cement mill 956 where it is combined with carbon coproduct (from carbon silo 941) and raw material(s) (from additive silo(s) 955). The resulting cement (which includes carbon coproduct) can be stored in finished cement silos 960.

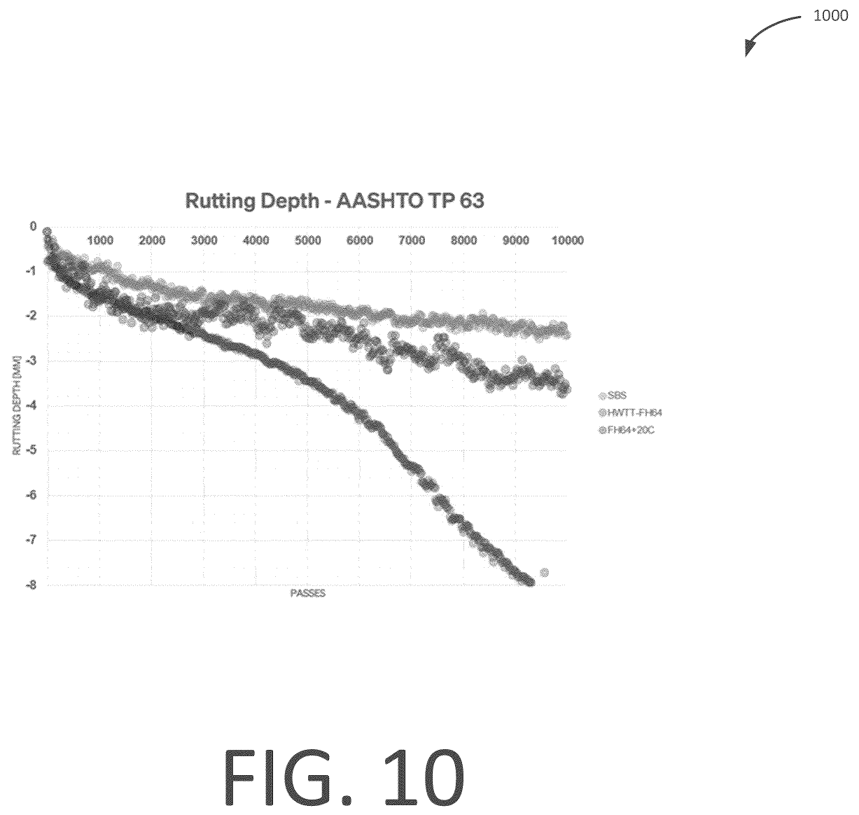

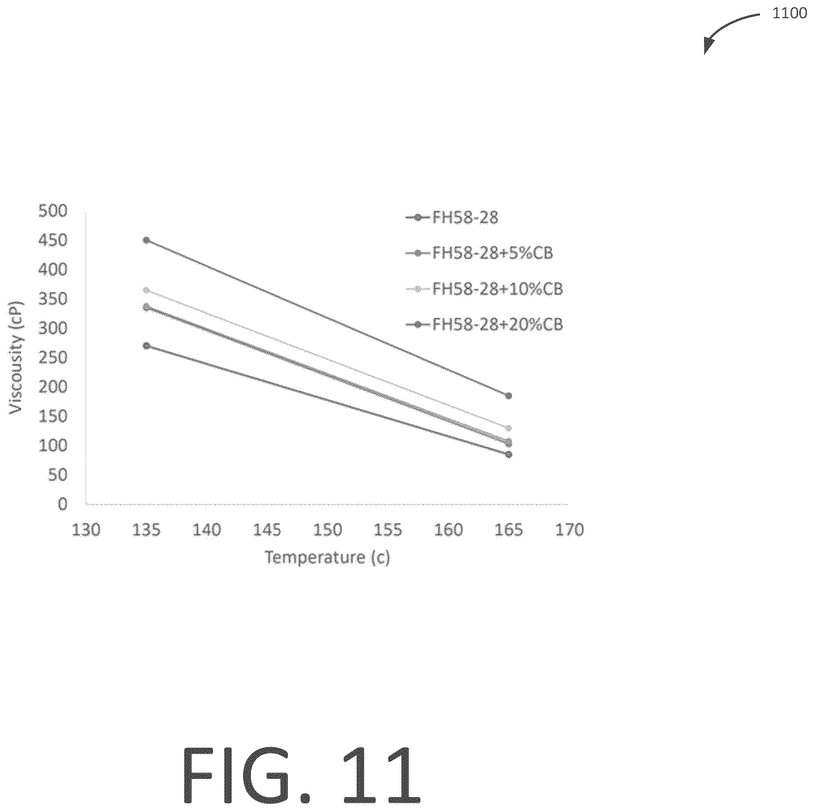

FIGS. 10 and 11 illustrate data/plots showing the positive effects of using carbon coproduct from a pyrolysis reaction (particularly carbon coproduct that has been controlled/tailored for use in a binder mixture). For example, plot 1000 (depicted in FIG. 10) illustrates positive effects of tuned pyrolysis carbon added to asphalt. For instance, plot 1000 depicts that an FH64 asphalt blend fails after 10000 Hamburh rutting wheel passes, but by replacing 20% of the binder with carbon, the mixture performs almost as well as an SBS polymer-modified blend, with SBS being much more expensive. Graph/plot 1100 (depicted in FIG. 11) shows that with up to 20% addition of tuned pyrolysis carbon, the mixture viscosity is minimally increased, with the viscosity staying under 500 cP. This means that the carbon-modified bitumen can be conventionally processed. In some embodiments, the results depicted in FIGS. 10 and 11 can be achieved through the binder mixture, method of producing a pavement mixture, method of producing a carbon coproduct, and/or system of producing pavement that are discussed herein.

Embodiments of a pyrolysis reaction and uses for carbon coproduct from such reactions are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within 10% of a given value or limit. Purely by way of example, an approximate ratio means within 10% of the given ratio.

Several embodiments of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A binder mixture, wherein the binder mixture comprises:
a carbon coproduct, wherein the carbon coproduct is a coproduct from a pyrolysis reaction; and
a binding agent.

2. The binder mixture of claim 1, wherein the carbon coproduct is sequestered in the binder mixture.

3. The binder mixture of claim 1, wherein less than or equal to 30% of the binder mixture is the carbon coproduct.

4. The binder mixture of claim 1, wherein the binder mixture is part of a pavement mixture.

5. The binder mixture of claim 4, wherein the pavement mixture is at least one of asphalt, cement, and concrete.

6. The binder mixture of claim 5, wherein the pavement mixture is asphalt, and wherein the asphalt is a hot mix asphalt, a warm mix asphalt, or a cold mix asphalt.

7. The binder mixture of claim 6, wherein:
the pavement mixture is asphalt;
the binding agent is bitumen; and
the pavement mixture comprises the binder mixture, aggregates, fines, and fillers.

8. The binder mixture of claim 7, wherein less than or equal to 15% of the pavement mixture is the binder mixture.

9. A method of producing a pavement mixture, the method comprising:
receiving a carbon coproduct, wherein the carbon coproduct is a coproduct from a pyrolysis reaction;
receiving a binding agent; and
blending together the carbon coproduct and the binding agent.

10. The method of claim 9, wherein blending together the carbon coproduct and the binding agent is at least partially powered from at least a portion of hydrogen gas from the pyrolysis reaction.

11. The method of claim 10, further comprising:
pyrolyzing a hydrocarbon feedstock to produce the carbon coproduct and the hydrogen gas, wherein the carbon coproduct is received from a pyrolysis reactor.

12. The method of claim 9, wherein blending together the carbon coproduct and the binding agent results in a binder mixture.

13. The method of claim 12, wherein the carbon coproduct is tailored to have characteristics that improve properties of the binder mixture.

14. The method of claim 13, wherein the characteristics of the carbon coproduct include one or more of particle size, particle morphology, particle allotrope, purity, hydrophobicity, and oil content.

15. The method of claim 12, further comprising:
subsequently mixing the binder mixture with additional pavement materials.

16. The method of claim 12, wherein:
blending together the carbon coproduct and the binding agent comprises:
adding the carbon coproduct into a mixing silo,
adding the binding agent into the mixing silo, and
agitating the binding agent and the carbon coproduct until homogeneous, resulting in the binder mixture.

17. The method of claim 9, further comprising:
receiving one or more pavement materials; and
wherein the blending comprises blending together the one or more pavement materials, the carbon coproduct, and the binding agent.

18. The method of claim 17, wherein blending together the one or more pavement materials, the carbon coproduct, and the binding agent comprises:
adding the one or more pavement materials to a mixing drum,
adding the binding agent and the carbon coproduct to the mixing drum, and
agitating the one or more pavement materials, the binding agent, and the carbon coproduct until homogeneous, resulting in the pavement mixture.

19. The method of claim 9, wherein:
the pavement mixture is asphalt; and
the binding agent is bitumen.

20. A method of producing a carbon coproduct, the method comprising:
receiving a hydrocarbon;
tailoring a pyrolysis reactor to control a carbon coproduct;
splitting the hydrocarbon within the pyrolysis reactor such that at least a portion of the hydrocarbon converts into hydrogen gas and the controlled carbon coproduct; and
separating the hydrogen gas and the carbon coproduct, wherein the carbon coproduct is tailored for a binder mixture.

21. The method of claim 20, wherein the tailoring the pyrolysis reactor controls at least one of a particle size, particle morphology, particle allotrope, purity, hydrophobicity, and oil content of the carbon coproduct in order to improve its compatibility with a binder mixture.

22. The method of claim 20, wherein the carbon coproduct comprises at least one of an iodine absorption between 1 mL/100 g and 30 mL/100 g, an oil absorption between 20 cm³/100 g and 100 cm³/100 g, a nitrogen surface area between 1 m²/g and 100 m²/g, an average primary particle size between 50 nm and 10000 nm, and an oil content between 0% and 25% by mass.

23. The method of claim 20, wherein tailoring the pyrolysis reactor to control the carbon coproduct comprises:
adjusting one or more factors of the pyrolysis reactor.

24. The method of claim 23, wherein the one or more factors comprise at least one of average reactor temperature, reactor temperature profile, flowrate of feedstock into the pyrolysis reactor, flowrate of fuel to the pyrolysis reactor, reactor residence time, feedstock composition, Reynolds number of the pyrolysis reactor, a use of a catalyst in a part of the pyrolysis reactor, and an addition of another energy type to the pyrolysis reactor.

25. The method of claim 20, wherein separating the hydrogen gas and the carbon coproduct comprises:
immediately removing the carbon coproduct from a product stream of the pyrolysis reactor.

26. The method of claim 20, wherein separating the hydrogen gas and the carbon coproduct comprises:
running a product stream of the pyrolysis reactor, the product stream comprising the hydrogen gas and at least a portion of the carbon coproduct, through one or more post-production filters.

27. The method of claim 20, wherein the carbon coproduct is a mixture of carbon particles and oils, wherein the oils comprise products from the pyrolysis reaction other than solid carbon and the hydrogen gas, resulting in a mixed solids carbon coproduct.

28. A system for producing pavement, the system comprising:
a pyrolysis reactor, wherein the pyrolysis reactor splits a hydrocarbon, resulting in a hydrogen gas product and a carbon coproduct; and
a pavement system, wherein the pavement system forms a pavement mixture comprising the carbon coproduct.

29. The system of claim 28, wherein the pyrolysis reactor and the pavement system are within a same facility.

30. The system of claim 28, wherein a portion of the hydrogen gas product is recycled to power the pyrolysis reactor.

31. The system of claim 28, wherein a portion of the hydrogen gas product is recycled to power one or more components of the pavement system.

32. The system of claim 28, wherein:
the pyrolysis reactor is tailored to produce the carbon coproduct with characteristics that are suitable for the pavement mixture;
one or more portions of hydrogen gas are used to power one or more components of the pavement system; and
the carbon coproduct replaces a portion of binding agent in the pavement mixture.

33. The system of claim 28, wherein the pavement system produces at least one of pavement binder, asphalt, cement, and concrete.
